(19) United States
(12) Patent Application Publication
(10) Pub. No.: US 2015/0211931 A1
(43) Pub. Date: Jul. 30, 2015

(54) SYSTEM FOR TRACKING CABLE TETHERED FROM MACHINE

(71) Applicant: Caterpillar Inc., Peoria, IL (US)

(72) Inventors: Qi Wang, Pittsburgh, PA (US); Nigel P. Boswell, Ferny Grove (AU)

(73) Assignee: Caterpillar Inc., Peoria, IL (US)

(21) Appl. No.: 14/681,132

(22) Filed: Apr. 8, 2015

(51) Int. Cl. G01J 5/00; G01J 5/10

(52) U.S. Cl. CPC G01J 5/0096; G01J 5/10; G01J 2005/0077

(57) ABSTRACT

A system for locating a cable tethered from a machine along a worksite is disclosed. The system includes a thermal camera configured to detect an infrared radiation emitted by a surrounding area of the machine within fields of view of thermal camera. A location unit generates a position of the machine. The system includes a processing device disposed on the machine and in communication with the thermal camera and the location unit. The processing device determines a location of the cable based on signals from the thermal camera and the location unit. The system further includes a server remotely located with respect to the machine and disposed in communication with the processing device. The server is configured to record locations of the cable at different instances of time and generates a map of the cable based on the locations of the cable.

### TECHNICAL FIELD

The present disclosure relates to system for tracking a cable tethered from a machine, more specifically it relates to a system for tracking a cable using thermal imaging.

### BACKGROUND

Machines such as excavators, mining shovels, loaders, drills and the like, are typically used for mining or other earth moving operations. In some cases, such machines may be either electrically powered by a remotely located power source. For example, drills which are employed to dig and load material may be connected to the remote power source, such as an electrical generator, via electric cables that are tethered to a rear portion of the mining shovels. The electric cables may be running on the ground along the worksite during operation of the machine and may run off a spool that allows the operating cable length to change as needed as the machine moves from one work location to another. As an electric drill moves from one drilling position to another drilling position to execute a desired operation, the position of a tethered electric cable will change. As a result, the position of an electric cable in these operations may be difficult to track, which can be problematic for other machines operating on the site.

Off-highway trucks and other machines typically found on a worksite may need to navigate in the vicinity of the remotely powered machine. For example, off-highway trucks may move to and from an excavating location to transport the earthen material from the worksite. An operator of the off-highway truck may have to avoid contact with the electric cables so as to prevent damage to both the electric cables and the truck. However, mobility and navigation around the electric cables may be difficult because the operator may be unable to see the ground, and thus locate the electric cables near the truck. Environmental and site conditions may also impede an operator's ability to locate the cable.

For reference, U.S. Pat. No. 8,332,106 (the '106 patent) discloses a tether tracking system for a mobile machine. The tether tracking system may have a spool located on the mobile machine to selectively dispense and reel in a tether extending from the mobile machine to a stationary source as the mobile machine travels about a worksite. The tether tracking system may also have at least one sensor associated with the spool to generate a first signal indicative of a spool parameter, a locating system associated with the mobile machine to generate a second signal indicative of a location of the mobile machine, and a controller in communication with the at least one sensor and the locating system. The controller may be configured to determine a tether avoidance zone based on the first and second signals. However, the tether tracking system of the '106 patent may require sensors in addition to the sensor associated with the spool in order to accurately determine the position of the tether along the worksite. This may increase a cost of the tether tracking system.

### SUMMARY OF THE DISCLOSURE

In an aspect of the present disclosure, a system for tracking a cable tethered from a machine along a worksite at or above a surface of the worksite during operation is provided. The system includes a thermal camera configured to detect an infrared radiation emitted by a surrounding area of the machine within a field of view of the thermal camera. The system further includes a location unit configured to generate a location of the machine.

The system also includes a processing device disposed on the machine. The processing device is configured to be in communication with the thermal camera and the location unit. The processing device includes an image module configured to receive data from the thermal camera and generate a two dimensional thermal image of the surrounding area of the machine within the field of view of the thermal camera. The processing device also includes a cable detection module configured to receive the two dimensional thermal image from the image module. The cable detection module is further configured to search for a high temperature region and a pair of lines in the two dimensional thermal image and determine a location of the cable with respect to the machine. The processing device also includes a fusion module configured to receive the location of the machine from the location unit and the location of the cable from the cable detection module. The fusion module is further configured to generate a location of the cable based on the location of the machine and the location of the cable. The system further includes a server remotely located with respect to the machine and disposed in communication with the processing device. The server is configured to record locations of the cable at different instances of time and generate a map of the cable based on the locations of the cable

Other features and aspects of this disclosure will be apparent from the following description and the accompanying drawings.

### BRIEF DESCRIPTION OF THE DRAWINGS

FIG. 1 illustrates a pictorial view of a worksite including a system for tracking a cable associated with a machine in the worksite, according to an embodiment of the present disclosure;

FIG. 2 illustrates an enlarged view of the encircled portion in FIG. 1, showing a rear part of the machine in FIG. 1; and

FIG. 3 is block diagram illustrating the system for tracking the cable associated with the machine, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

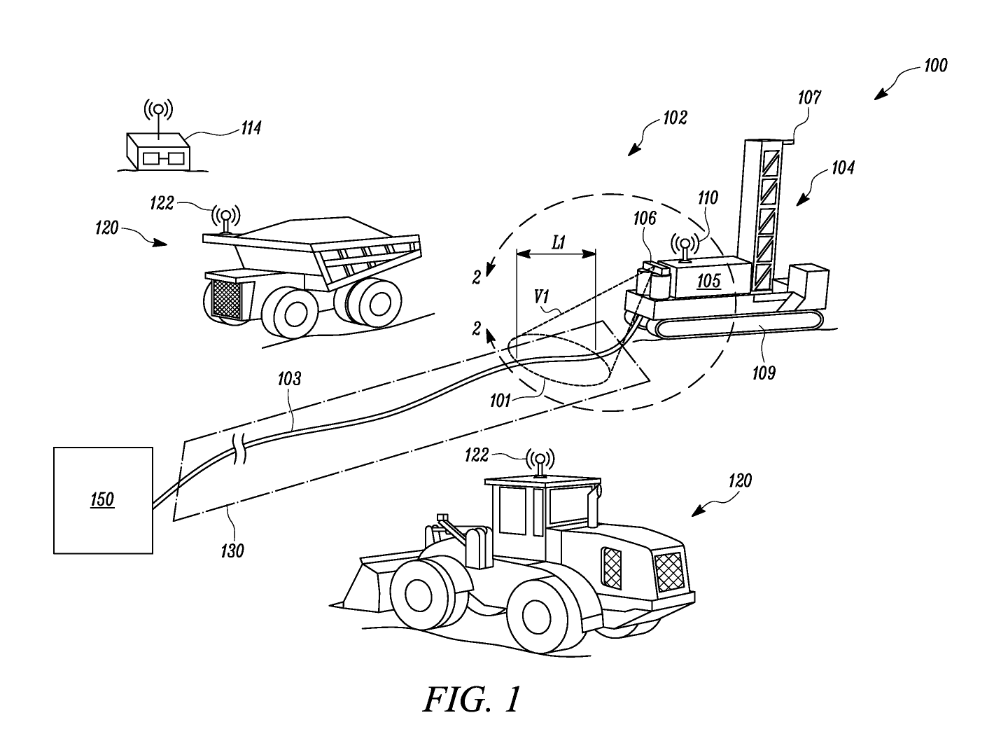

FIG. 1 shows a perspective view of a worksite 100. The worksite 100 may be a mine site, a landfill, a quarry, a construction site, or any other type of worksite. In a worksite, there may be multiple machines operable to perform various tasks. The tasks may include drilling, excavating, hauling, dumping, grading and the like. A machine 104 is shown to be operating at the worksite 100. In the illustrated embodiment, the machine 104 is a blasthole drill. However, the machine 104 may be a mining shovel, a loader, an excavator, a dozer, a mining truck or the like.

The machine 104 may include an implement 107 disposed on a body 105 of the machine 104. In the illustrated embodiment, the implement 107 is a drill. However, in alternate embodiments, the implement 107 may be a power shovel, a ripper, a bucket or the like. The machine 104 includes a set of ground engaging members 109 for propulsion and steering on the worksite 100. In the illustrated embodiment, the ground engaging members 109 are track assemblies. Alternatively, the ground engaging members 109 may be wheels. The machine 104 may further include one or more electric motors (not shown) configured to provide propulsion to the machine 104, and/or to actuate the implement 107.

As shown in FIG. 1, a cable 103 is tethered to the machine 104 at a rear end thereof. The cable 103 may be configured to transmit electric power to the electric motors from a power source 150. The power source 150 may be remotely located from the machine 104. The cable 103 may include one or more electrically conductive members, such as wires, encased within an outer casing. The power source 150 may also be located remotely with respect to the worksite 100. The power source 150, for example, may be an electrical power generator or a standard power grid or any other source of electrical power known in the art. During operation of the machine 104, a temperature of the cable 103 increases due to electric current flowing therethrough. The temperature of the cable 103 is generally higher than a temperature of the surrounding objects such as soil, rocks, sand, and the like.

The machine 104 may travel along the worksite 100 to multiple locations. The machine 104 may work in conjugation with one or more mobile equipment 120. The mobile equipment 120 may be, for example, an off-highway truck for transporting material from the worksite 100. In the illustrated embodiment, the mobile equipment 120 includes an off-highway truck and a loader. The mobile equipment 120 may be autonomously controlled or manually controlled by an operator.

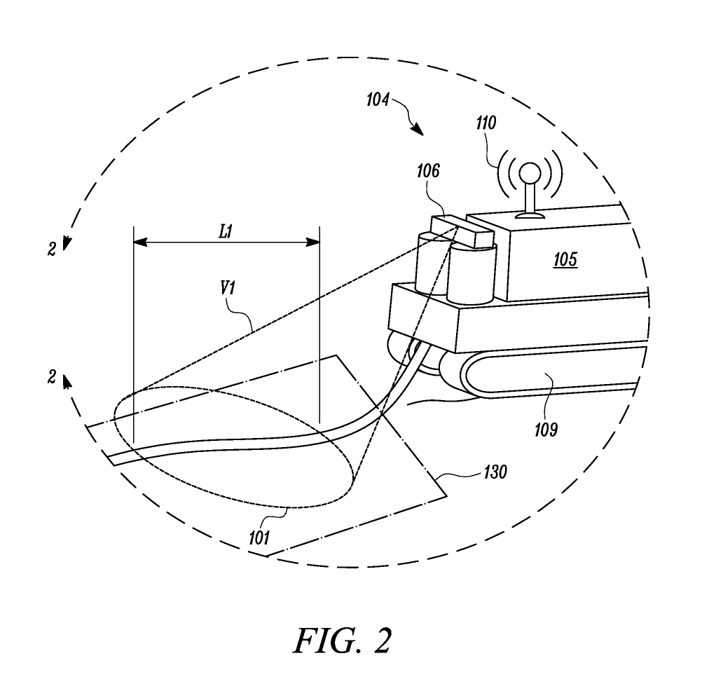

Referring to FIGS. 1 and 2, a system 102 is provided to track the cable 103, according to an embodiment of the present disclosure. The system 102 includes a thermal camera 106 configured to detect an infrared radiation emitted by a surrounding area 101 of the machine 104 within a field of view ‘V1’ of the thermal camera 106. The thermal camera 106 may be disposed on the body 105 of the machine 104. The thermal camera 106 may include an infrared radiation detector (not shown) configured to detect the infrared radiation from the surrounding area 101. The thermal camera 106 may continuously or periodically scan the surrounding area 101 for the infrared radiation. The thermal camera 106 may be positioned on the machine 104 so as to have a sufficient field of view ‘V1’ to monitor the surrounding area 101 at the worksite 100 during travel of the machine 104, Specifically, the field of view ‘V1’ of the thermal camera 106 may be sufficient to cover a portion of the cable 103. It may be also contemplated that the field of view ‘V1’ may be a 360 degree field of view with respect to the machine 104. The thermal camera 106 may generate data identifying different temperature region in the field of view ‘V1.’

The system 102 further includes a location unit 110 configured to generate a location of the machine 104. In an example, the location unit 110 may be disposed on the body 105 of the machine 104. However, it may be contemplated that the location unit 110 may be disposed at any location on the machine 104. The location unit 110 may be configured to generate a local or global coordinates of the machine 104 relative to the worksite 100. In an example, the location unit 110 may be a satellite positioning system, for example, a Global Positioning System (GPS). Thus, the location unit 110 may be configured to generate GPS coordinates of the machine 104.

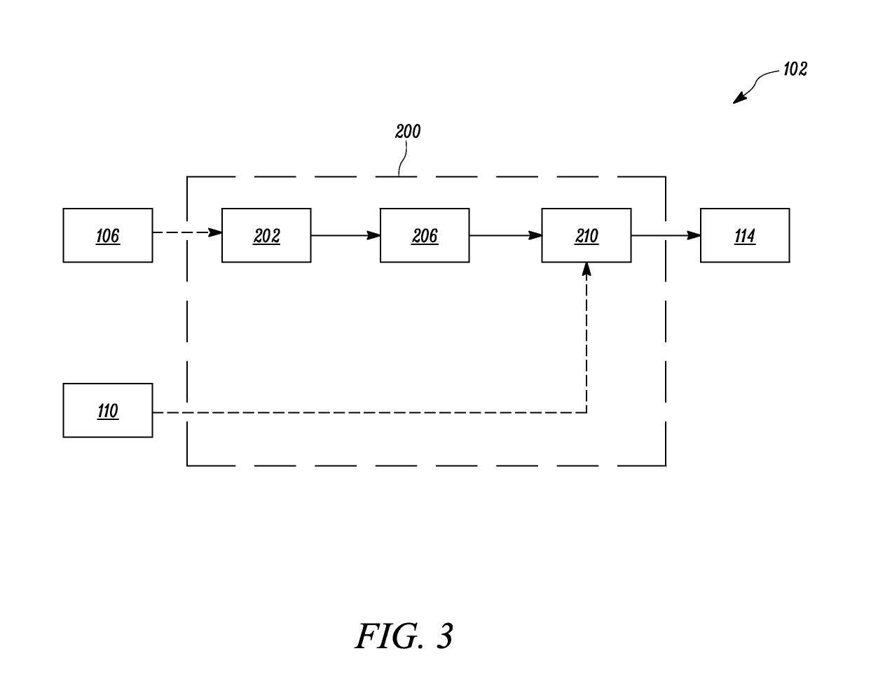

FIG. 3 illustrates a block diagram of the system 102, according to an embodiment of the present invention. Referring to FIGS. 2 and 3, the system 102 further includes a processing device 200 disposed on the machine 104. In an example, the processing device 200 may be disposed in an operator cab (not shown) of the machine 104. The processing device 200 may embody a single microprocessor or multiple microprocessors configured for receiving signals from the various components of the system 102. Numerous commercially available microprocessors may be configured to perform the functions of the processing device 200. It should be appreciated that the processing device 200 may embody a machine microprocessor capable of controlling numerous machine functions. A person of ordinary skill in the art will appreciate that the processing device 200 may additionally include other components and may also perform other functions not described herein.

The processing device 200 is configured to communicate with the thermal camera 106 and the location unit 110. The processing device 200 further includes an image module 202 disposed in communication with the thermal camera 106. The image module 202 is configured to receive data from the thermal camera 106 and generate a Two Dimensional (2D) thermal image of the surrounding area 101 of the machine 104 within the field of view ‘V1’ of the thermal camera 106.

The processing device 200 further includes a cable detection module 206 disposed in communication with the image module 202. The cable detection module 206 is configured to receive the 2D thermal image from the image module 202. The cable detection module 206 is further configured to search for one or more high temperature regions and one or more pairs of lines in the two dimensional thermal image received from the image module 202. In an embodiment, the lines of each of the pairs of lines are parallel to each other. The cable detection module 206 also determines a location of the cable 103 with respect to the machine 104 based on the location of the high temperature regions and the pair of lines within the 2D thermal image. Specifically, the cable detection module 206 is configured to search for the pairs of lines in the high temperature regions in the 2D thermal image. In an embodiment, the 2D thermal image may be generated in a multi-color scale or a monochromatic scale, such as a gray scale. In an embodiment, the high temperature region may correspond to red color pixels in the 2D thermal image. In the illustrated embodiment, the cable detection module 206 may be configured to detect the red color pixels in the 2D thermal image.

The cable detection module 206 may also be configured to determine lengths of the pairs of lines. Further, the cable detection module 206 may be configured to compare lengths of the pairs of lines with a preset threshold ‘L’ of the cable 103. The preset threshold length ‘L’ may correspond to a length ‘L1’ (shown in FIG. 1) of the field of view ‘V1’ of the thermal camera 106. However, it may also be contemplated that the preset threshold ‘L’ may be of any suitable value. In an example, the preset threshold ‘L’ may also be based on a user input. The cable detection module 206 may then retain the pairs of lines having lengths greater than or equal to the preset threshold ‘L’. Further, the location of the cable 103 with respect to the machine 104, as generated by the cable detection module 206, may include locations of the pairs of lines in the high temperature region of the 2D thermal image having lengths greater than the preset threshold ‘L’.

The processing device 200 also includes a fusion module 210 disposed in communication with the location unit 110 and the cable detection module 206. The fusion module 210 is configured to receive the location of the machine 104 from the location unit 110 and the location of the cable 103 from the cable detection module 206. Specifically, the fusion module 210 is configured to determine the position of the cable 103 within the worksite 100 based on the locations of the pair of lines having lengths greater than the preset threshold ‘L’ and the location of the machine 104.

Referring to FIGS. 1 to 3, the system 102 further includes a server 114 remotely located with respect to the machine 104 and disposed in communication with the processing device 200. The server 114 is configured to record locations of the cable 103 received from the fusion module 210 of the processing device 200 at different instances of time and generate a map of the cable 103 based on the locations of the cable 103. The server 114 may also be configured to determine an avoidance region 130 (shown in FIG. 1) based on the location of the cable 103. The avoidance region 130 may correspond to a region for avoidance by the mobile equipment 120 and personnel. The avoidance region 130 shown in FIG. 1 is exemplary in nature, and the shape and/or size of the avoidance region 130 may also vary based on various factors in addition to the position of the cable 103, such as an amount of slack in the cable 103. The server 114 may also be configured to receive a location of mobile equipment 120 from the positioning device 122 of the mobile equipment 120. The server 114 may also be configured to provide the map of the cable 103 and the avoidance region 130 to a controller (not shown) of the positioning device 122 of the mobile equipment 120. The positioning device 122 of the mobile equipment 120 may be a satellite positioning system, for example a Global Positioning System (GPS). The positioning device 122 may be disposed at any location on the mobile equipment 120.

### INDUSTRIAL APPLICABILITY

The present disclosure is related to the system 102 for tracking the cable 103 connected between the power source 150 and the machine 104 such that the avoidance region 130 may be determined in the worksite 100. The avoidance region 130 may correspond to a region of the worksite 100 defined around the cable 103. The system 102 detects the high temperature regions in the worksite 100 using the thermal camera 106.

In an embodiment, the server 114 may generate a map of the worksite 100. Alternatively, the server 114 may access a map stored in a database. The server 114 may also determine locations of the mobile equipment 120, the machine 104, the power source 150, the cable 103, various mining regions, and the like on the map. Further, the server 114 may determine the location of the avoidance region 130 on the map of the worksite 100. In case one or more of the mobile equipment 120 are autonomously controlled, the server 114 may regulate the mobile equipment 120 based on the avoidance region 130, for example, by stopping the mobile equipment 120 from entering the avoidance region 130, or by executing an alternative path for the mobile equipment 120 to travel. In case one or more of the mobile equipment 120 are manually controlled, the server 114 may communicate information related to the avoidance region 130 to operators and/or controller (not shown) of the positioning device 122 of the mobile equipment 120, for example, by displaying the location of the avoidance region 130 (and thus the cable 103) on a display within the operator's view, or providing other visual and/or audible alarms. Additionally, the server 114 may also communicate information related to the avoidance region 130 to other personnel overseeing various operations in the worksite 100.

The server 114 may update the avoidance region 130 in real time based on various factors, such as changes in the position of the cable 103 and location of the machine 104 during operation. The avoidance region 130 may also be changed based on previous positions of the cable 103. Thus, the avoidance region 130 may enable the mobile equipment 120 and personnel to avoid contact with the cable 103 so as to prevent damage to the cable 103 and/or the mobile equipment 120.

Further, the system 102 includes only the thermal camera 106 to determine the position of the cable 103. Hence, the system 102 may not require any additional sensors. Moreover, since the system 102 detects the infrared radiation emitted by the surrounding area 101 and generates the 2D thermal image of the surrounding area 101, the system 102 may be able to function in low light conditions (for example nighttime) and in various environment conditions, such as fog, snow, dust etc. The system 102 may also enable detection of the cable 103 in blind spots of the machine 104.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for tracking a cable tethered from a machine along a worksite at or above a surface of the worksite during operation, the system comprising:
a thermal camera configured to detect an infrared radiation emitted by a surrounding area of the machine within a field of view of the thermal camera;
a location unit configured to generate a location of the machine;
a processing device disposed on the machine and in communication with the thermal camera and the location unit, the processing device comprising:
an image module configured to receive data from the thermal camera and generate a two dimensional thermal image of the surrounding area of the machine within the field of view of the thermal camera;
a cable detection module configured to receive the two dimensional thermal image from the image module, the cable detection module further configured to search for a high temperature region and a pair of lines in the two dimensional thermal image, and determine a location of the cable with respect to the machine based on the locations of the high temperature region and the pair of lines within the two dimensional thermal model; and
a fusion module configured to receive the location of the machine from the location unit and the location of the cable from the cable detection module, the fusion module further configured to generate a location of the cable based on the location of the machine and the location of the cable; and
a server remotely located with respect to the machine and disposed in communication with the processing device, the server configured to record locations of the cable at different instances of time and generate a map of the cable based on the locations of the cable.
